(19) United States
(12) Patent Application Publication
(10) Pub. No.: US 2026/0132058 A1
(43) Pub. Date: May 14, 2026

(54) NOVEL REGENERATION OF MIXED BED ION EXCHANGE RESINS FOR SEAWATER DESALINATION

(71) Applicant: HYDRIC DESALINATION PTY LTD, Curtin (AU)

(72) Inventor: Richard PASHLEY, Cook (AU)

(73) Assignee: HYDRIC DESALINATION PTY LTD, Curtin (AU)

(21) Appl. No.: 19/120,482

(22) PCT Filed: Oct. 12, 2023
(86) PCT No.: PCT/AU2023/051005

§ 371 Date: Apr. 11, 2025

(30) Foreign Application Priority Data
Oct. 27, 2022 (AU) 2022903176
Aug. 13, 2023 (AU) 2023902566

(51) Int. Cl. C02F 1/42; B01J 49/09; B01J 49/50; C02F 101/00; C02F 103/08

(52) U.S. Cl. CPC C02F 1/42; B01J 49/09; B01J 49/50; C02F 2001/427; C02F 2101/006; C02F 2103/08; C02F 2303/16

(57) ABSTRACT

The present invention is directed at a novel ion exchange regeneration process where there is no need for resin separation or acid and base consumption for regeneration. An exhausted strong acid/strong base mixed bed resin suitable for seawater desalination can be regenerated in situ, that is without the need for bead separation, by washing with high pressure (<10 atm) concentrated ammonium bicarbonate (AB) solution (up to a concentration of 8-10 m) at moderately elevated temperatures, of up to 60°-80° C. Under these conditions a relatively small amount of AB solution can be used to regenerate an exhausted mixed bed resin, converting it into a form where it is saturated with absorbed NH₄⁺ and HCO₃⁻ ions. This resin can then be used for seawater desalination, via direct exchange with Na⁺ and Cl⁻ ions, as well as other ions in seawater. By this method the volume of produced drinking water can be at least 2-4 times the volume of the AB solution required, which is then discarded as waste concentrated salt solution. The AB dissolved in the desalinated product water can be easily thermally decomposed, by heating to 60°-80° C., or lower under a reduced pressure, which completely removes the AB in the form of the emitted gases NH₃ and CO₂, which can then be captured and redissolved in cool water to reform the regenerant solution. The application of an increased pressure for driving super saturated ammonium bicarbonate regeneration can also be carried out using guided ultrasonic waves. A suitable frequency and intensity of wave-guided ultrasonic waves, transmitted along the inside of a container housing the exhausted mixed bed resin, immersed in concentrated or supersaturated AB solution, drives the ion exchange regeneration process. Alternatively, the pressure applied to the resin could be generated via the centrifugal forces produced inside a spinning drum.

### TECHNICAL FIELD

The present invention relates to an improved method for the regeneration of exhausted mixed bed ion exchange resins, especially directed for applications in seawater and brackish water desalination. The process disclosed in the present invention can also be used for the recovery of magnesium carbonate/bicarbonate precipitate which is derived from the significant levels of Mg²⁺ in seawater. In addition, the process disclosed in the present invention can be used for the removal of many other valuable multivalent ions such as radioactive strontium (Sr²⁺) and rare earth metals from wastewater.

### Background to the Technology

Current desalination techniques like distillation and reverse osmosis (RO) are so energy intensive that they are often marginal economically. Seawater RO (SWRO) requires sophisticated control systems and expensive specialist membranes. It also requires seawater pre-treatment to protect the membranes from fouling and, even so, the membranes must be regularly discarded and replaced. Seawater must be pressured typically up to 70 atm and sophisticated pressure recycling systems are used to reduce costs. Thermal methods are critically controlled by the thermal energy demand of the high enthalpy of vaporisation of water, and even with energy recovery systems these units can only be made viable when associated with the availability of industrial waste heat, such as when built next to power stations and other industrial plants.

The ancient Greeks knew how to produce ‘sweet’ water from seawater via the simpler process of ion exchange by flowing seawater through clayey soil. The ion exchange process was modernised by the development of the first plastic or polymer based synthetic resins. This technology offers several advantages in desalination. Some of these come from conventional resin ion exchange techniques which have advantages like low-input pressure, simple setup, high efficiency and does not require extensive feedwater pre-treatment.

Mixed bed ion exchange processes are often used to produce ‘distilled water’ from slightly salty or even brackish water but are rarely used to produce drinking water from seawater. This is because the strong anion and strong cation exchange resin beads must be regenerated on exhaustion, requiring their physical separation and washing with strong acid and base solutions, which not only damages the resin polymer but are also completely consumed, involving prohibitive cost.

### PRIOR ART

Recently, it has been disclosed that ammonium bicarbonate (AB) solutions can be used to regenerate these mixed bed resins in situ, without the need to separate cationic and anionic resins, giving a simpler, more efficient process, and increasing the resin's lifespan, as there is no exposure of these resins to the strong acids and bases used in conventional regeneration methods. Such a method is disclosed in WO/2020/118371. A major improvement comes from completely removing the need to consume large volumes of expensive acids and bases.

### Problem with the Prior Art

An efficient, commercial process must produce a significantly larger volume of desalinated water than is required for the AB solutions needed to regenerate the exhausted mixed bed resins. So far, this issue has not been solved.

The desalination of seawater typically involves the removal of significant levels of dissolved Mg²⁺ and SO₄²⁻, in addition to Na⁺ and Cl⁻ ions, and divalent ions are more favorably absorbed onto the resin, which makes regeneration more difficult. This invention is aimed at solving the issue faced by the AB regeneration method when it is applied specifically to the production of drinking water from seawater.

Typical main ionic components in seawater are:
Cl⁻: 0.55 M, Na⁺: 0.47 M, Mg²⁺: 0.053 M, SO₄²⁻: 0.028 M

All of these ions can be electrostatically bound to the oppositely charged groups on the ion exchange resins and they can all be removed by exposure to a higher concentration of an ion of the same type, that is cation for cation and anion for anion. However, divalent ions must be displaced using a higher concentration of monovalent ions of the same charge.

In order to regenerate the seawater exhausted mixed bed resin, it is important to use a significantly higher concentration of a solute, such as AB, and this is possible because of the high water solubility of AB. Increasing the temperature is one way of increasing the concentration of the AB solution. However, increasing the temperature can cause AB to decompose into ammonia and carbon dioxide gases. This invention aims to address this issue.

### SUMMARY OF THE INVENTION

Ammonium bicarbonate is very soluble in water, especially with increasing temperature. However, raising the temperature also causes the salt to decompose into ammonia and carbon dioxide gases. In order to address this issue, The present invention discloses an efficient AB regeneration process which is driven by using increased pressure and temperature to create a supersaturated AB solution. The pressure required for the AB regeneration process can be supplied by the application of direct pressure or via heating, ultrasound or even using centrifugal forces.

When excess salt is added to an ammonium bicarbonate solution, it will decompose as the temperature is increased, up to about 60° C., in a sealed vessel, and this can be used to create an increase in partial pressure of both NH₃ and CO₂, which acts to drive the AB regeneration of the mixed bead resin.

For example, AB starts to decompose in aqueous solutions above about 40° C., even though its solubility also increases, as shown below:

$$At 40 ° C . : AB solubility is 36.6 g / 100 g water - which corresponds to : 4.6 m .$$

$$At 60 ° C . : AB solubility is 60 g / 100 g water - which corresponds to : 7.6 m .$$

In accordance with the novel process of the present invention, at these higher temperatures the partial pressures are increased to prevent AB decomposition.

The required pressures to maintain a certain solubility can be estimated from Henry's law for gas solubility in solutions. Thus, for AB solubility at 4 atm pressure the solubility will increase to about 8 M, reducing the required volume of regenerant solution. Under these conditions of higher concentration and increased temperature, for resin regeneration, the productivity ratio of produced desalinated water vs AB regenerant solution volume, increases and can exceed the demands of commercial processes. This results in producing a surplus of desalinated water during the process. When supersaturated AB solution is heated in a pressure vessel, decomposition of AB raises the partial pressures of both ammonia and carbon dioxide and drives the regeneration process.

This finding of the present invention is also strongly supported by a very important consideration, which is based on a fundamental thermodynamic law, called Le Chatelier's Principle. Applied to the pressured regenerant process, this universal principle means that the increased (partial) pressure of NH₃ and CO₂ gases will drive the absorption of NH₄⁺ and HCO₃⁻ ions onto the resin and so remove them from solution, because they are always in dynamic equilibrium with ammonia and carbon dioxide gases, which is why pressure needs to be applied to prevent AB decomposition.

Le Chatelier's Principle predicts that this system will respond to oppose the applied pressure and it can only do this by forcing more of these ions into the resin. By comparison, Na⁺, Cl⁻, as well as Mg²⁺ and SO₄²⁻ ions, have no pressure change associated with whether they are in solution or on the resin and so are not driven one way or another by the application of pressure.

In addition, it should also be realised that since the NH₄⁺ and HCO₃⁻ ions are absorbed onto separate beads, i.e. anion and cation ion exchange beads, in the mixed bed, the different absorbed ions are physically separated by a mm or so and hence cannot decompose. This is because a water molecule must be extracted from the NH₄HCO₃ molecule in order to decompose into the two gases.

This makes AB regeneration with pressure ideal for mixed bed resins. Once AB is absorbed to the resin reducing this pressure won't make much difference and the NaCl concentrate can be drained off, especially if the temperature is allowed to return to room temperature before the pressure is released.

Any strong acid-base mixed bed resin can be used as the resin in the process disclosed in the present invention. One of the resins that is suitable for carrying out this invention is LEWATIT® MonoPlus SM 1000 KR resin, which is a ready-to-use mixed bed comprising strongly acidic gel-type cation and strongly basic gel-type anion exchange resins in fully regenerated form. In this mixed resin, anion ion exchanger capacity is half of the cation one, so they are mixed in 2:1 ratio. The functional group of the anion ion exchanger contains quaternary ammonium (quats) and the cation ion exchanger contains the sulfonate group.

This novel process is equivalent to the separation of the products produced in a chemical reaction, which is often used to drive the reaction forward and prevent the reverse reaction. It should be noted that although the present invention is more focused on the most difficult problem of seawater desalination, this process would also significantly further improve the productivity ratio for brackish water.

In addition, it is observed that the novel AB regeneration process of the present invention produces magnesium carbonate/bicarbonate precipitate as a byproduct which is derived from the significant levels of Mg²⁺ in seawater absorbed by the resin. Similarly, the process disclosed in the present invention can be used to remove many other valuable multivalent ions such as radioactive strontium (Sr²⁺) and rare earth metals in contaminated wastewater.

Essentially, the novel process of the present invention comprises the following main stages:

Stage 1: A continuous flow of an ionic solution such as seawater is passed through a mixed bed, strong acid and strong base resin, in which the ion exchange groups are initially saturated with NH₄⁺ and HCO₃⁻ ions, preferably by up flow of the feed water, to produce drinking water (volume Vp) containing essentially only desorbed NH₄⁺ and HCO₃⁻ ions.

Stage 2: the product water is heated to between 60-80 C to completely remove the AB solute as CO₂ and NH₃ gases, to produce the final product water (of volume Vp); or at lower temperatures with reduced pressures.

Stage 3: the released gases are collected by dissolving them initially in cool water and then further concentrated by dissolving under pressure (up to 10 atm) and heating of the solution to up to 80° C., to produce an AB regenerant solution of up to 8 m (of volume Vr).

Stage 4: the heated regenerant solution is then fed under pressure into the vessel (ion exchange column) holding the seawater exhausted resin. The vessel is sealed and continuously rolled or shaken to allow mixing for a period until the pressure in the vessel falls to a lower equilibrium value, indicating that the NH₄⁺ and HCO₃⁻ ions have replaced the resin absorbed seawater ions. When supersaturated AB solution is heated in the pressure vessel, decomposition of AB raises the partial pressures of both ammonia and carbon dioxide and drives the regeneration process.

Stage 5: the temperature and pressure in the resin vessel are then reduced to ambient conditions and the salt concentrate is allowed to completely drain from the resin (or is forced out by, for example, a pumped air flow) and is discarded (of volume approximately Vr).

The process then repeats from Stage 1.

### DETAILED DESCRIPTION OF THE INVENTION

Notwithstanding any other forms of this invention that may fall within the scope of the process and apparatus as disclosed, specific embodiments of the invention are described below, by way of example only, with reference to the accompanying drawings 1 to 3.

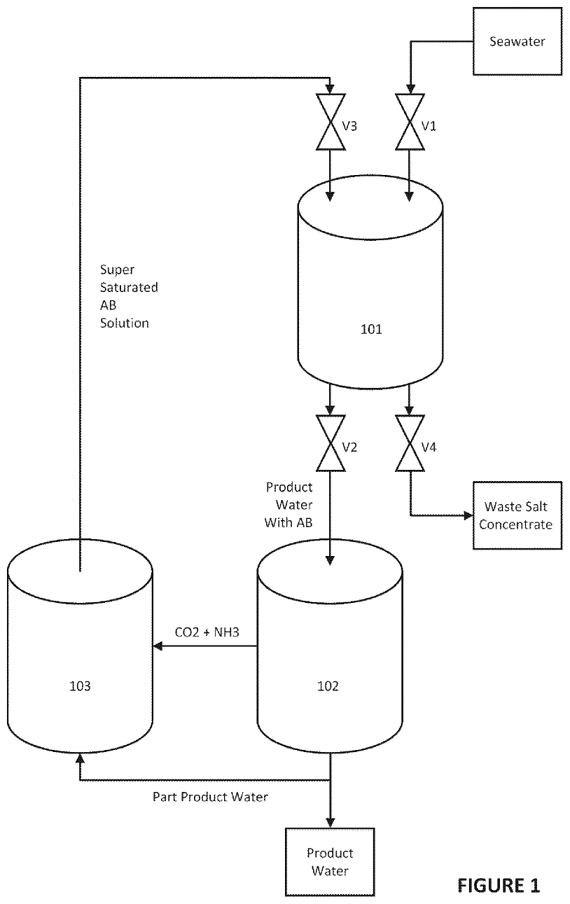

FIG. 1 is a schematic diagram of the desalination process according to the present invention including the regeneration step using super saturated ammonium bicarbonate solution under pressure. The reference numbers used in FIG. 1 to describe various features of the apparatus used in the invention are:
101—Ion Exchange vessel
102—Ammonium Bicarbonate Decomposition unit
103—Unit for making super saturated Ammonium Bicarbonate solutions
V1—Seawater isolation valve
V2—Product water with AB isolation valve
V3—Super Saturated AB solution isolation valve
V4—Waste Salt Concentrate isolation valve

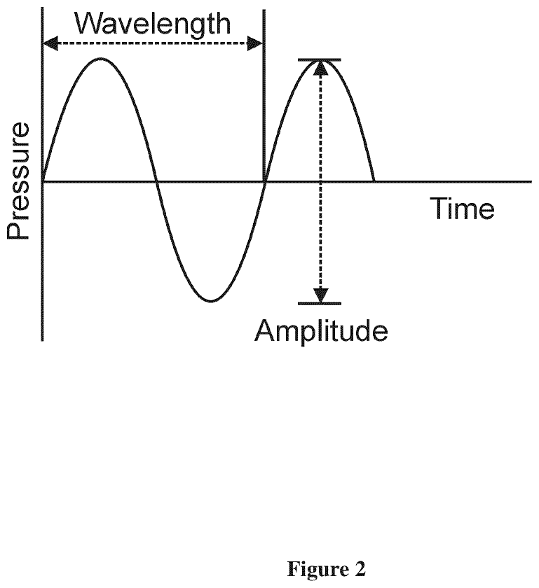

FIG. 2 is a Schematic diagram showing standard wave features.

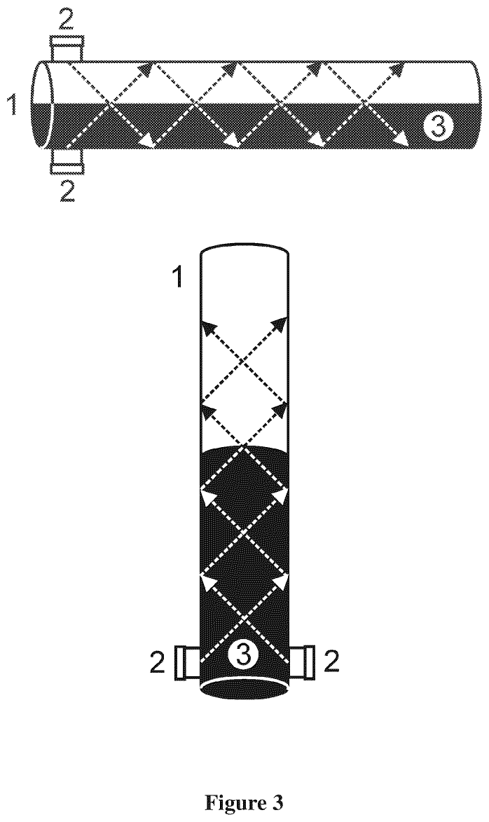

FIG. 3 is a schematic example of guided ultrasonic waves in a pipe vessel used for ion exchange. In this figure item 1 is a pipe shaped vessel which is used as an Ion Exchange unit which can be used either vertically or horizontally. Item 2 represents ultrasonic transducers or emitters. Item 3 is a strong acid-base mixed bed resin. This pipe vessel can be used either horizontally or vertically as shown in FIG. 3.

The arrangement of the apparatus for desalination of seawater using the present invention is described with reference to the FIG. 1 below:

In FIG. 1, item 101 is an ion exchange vessel, or a column filled with a strong acid-base mixed bed resin. In the operation cycle, the resin is in the form of Ammonium Bicarbonate (AB). During the operation cycle, valves V3 and V4 are in closed position. Valves V1 and V2 are in open position.

In the operational stage, seawater is pumped into the Ion exchange column 101 via the valve V1. As the seawater passes through the column, Na⁺ and Cl⁻ ions in seawater get exchanged with ammonium and bicarbonate ions in the resin.

The product water containing AB exits the Ion Exchange column 101 via the valve V2 and enters the vessel 102 which is used for decomposing the AB solution. Decomposition of AB is carried out by heating the vessel 102 to a suitable temperature (approximately 60° C.).

Clean water produced by decomposition of AB exits the vessel. CO₂ and NH₃ gas generated during the decomposition process are directed to vessel 103 where it is combined with some of the clean water generated by the decomposition process.

In vessel 103, CO₂, NH₃ and water are subjected to higher temperature (60° C.) and pressure (greater than 1 atm) to create a supersaturated AB solution. This supersaturated AB solution is pumped under pressure to Ion Exchange vessel or column 101 via valve V3 (while V1 and V2 are in closed position).

Supersaturated AB solution passes through the resin in the Ion Exchange column under pressure, exchanging Ammonium and Bicarbonate ions with Na⁺ and Cl⁻ ions attached to the resin. The concentrated wastes salt solution is discharged via valve V4.

After all the Na⁺ and Cl⁻ ions are removed, the cycle is changed to operation cycle again by pumping seawater through the ion exchange column 101 again.

A productivity ratio (Vp/Vr) can be targeted in the range 2-4 for typical seawater feed.

Another preferred embodiment of this invention is that the AB regeneration process can be driven by a positive pressure increase, acting in only one direction; such that the reverse ion exchange reaction cannot occur even when the pressure is either reduced or reversed. This is because the anion and cation exchange beads are physically separated and this prevents the thermal or low-pressure decomposition of AB, which can only occur via the combined salt. This embodiment is based on the observation that the pressure-driven replacement of the Na⁺ and Cl⁻ ions on the exhausted, mixed bed resin, by NH₄⁺ and HCO₃⁻ ions, can only act in one direction. This is because AB can only decompose in the combined salt state. The individual ions cannot decompose, even under the application of a negative pressure, because they are physically separated onto the two different ion exchange beads, that is, the anion and cation exchange beads.

This embodiment of the present invention uses guided ultrasonic waves of a suitable frequency and intensity, transmitted along the inside of a container housing the exhausted mixed bed resin, immersed in concentrated or supersaturated AB solution to apply the pressure in one direction. This embodiment could be used to substantially reduce the need for increasing both the background temperature and pressure, during the regeneration process, offering substantial energy savings, and also reducing the operational time required. At the end of the process the AB can be readily recycled through low temperature thermal decomposition, by heating to 60-80° C., which completely removes the AB in the form of the emitted gases NH₃ and CO₂, which can then be captured and redissolved in cool water, to reform the regenerant solution.

A suitable source of transient pressure could be efficiently supplied using ultrasonic waves to produce a pressure increase acting on the exchange reaction in only one direction. Such a pressure increase, passing through the exhausted resin, which when immersed in concentrated or supersaturated AB solution, will assist or even drive the regeneration in a low energy process. Ultrasonic waves are pressure waves with frequencies above the human audible range of 20 kHz. The speed of travel of these waves depends on the medium, in seawater this is about 1500 m/s. Human imaging ultrasonic scanners operate at higher frequencies of about 10 MHz. The wave pattern of such waves is shown in FIG. 2.

The speed of an ultrasonic wave is obtained by multiplying frequency by the wavelength. It follows that: the wavelength at 40 kHz is: 1500/20000=0.075 m or 7.5 cm and the wavelength at 10 MHz (such as human body scanners) is: 1500/107=0.00015 m or 0.15 mm. This shows that a wide range of frequencies and wavelengths are available for the transient increase in local pressure, which can be used to drive the AB ion exchange process.

Ultrasonic waves have been used for testing fluid-filled piping using point-by-point defect detection by bulk ultrasonic waves or long-range inspection by guided waves. The guided wave ultrasonic testing (GWUT) is more suitable for damage detection in large areas. The guided wave can propagate for a long distance along the tested structure and interrogate the whole structure in a short time. There are many different geometries used to generate wave guide configuration, depending on the required application. Such guided waves can be used in the process described in the present invention.

Ultrasonic transducers convert alternating current (AC) into ultrasound and vice versa. The transducers typically use piezoelectric transducers or capacitive transducers to generate or receive ultrasound. Piezoelectric crystals can oscillate in response to an applied voltage signal, over a wide frequency range. This oscillation can generate ultra-high frequency sonic waves. The piezoelectric transducer can be fitted either on the outside wall of the vessel or directly in contact with the fluid inside the vessel, depending on requirements.

FIG. 3 is a schematic representation of guided ultrasonic waveguide configuration used with a pipe vessel according to an aspect of the present invention.

As shown in FIG. 3, non-axisymmetric partial loading by a small single-element transducer excites multiple modes (both longitudinal and flexural guided waves) in a pipe. The excited flexural modes have displacement fields in all three directions (radial, circumferential, and axial). When the excitation source input is made with a wide range of frequencies, many more flexural guided wave modes are generated, and their diverse wavelengths are beneficial to generating a wide range of forced, pressure-driven interactions, suitable for supporting this pressure-driven ion exchange process throughout the entire enclosed fluid and resin mixture.

The process of the present invention has been described above in relation to desalination of seawater or brackish water. Similarly, the process can be used for the purification any other contaminated wastewater for the removal of multivalent ions, such as radioactive Sr²⁺ and ions of rare earth metals.

While various embodiments of the present invention have been described above, it should be understood that they have been presented by way of example only, and not by way of limitation. It will be apparent to a person skilled in the relevant art that various changes in form and details can be made therein to suit different situations without departing from the spirit and scope of the present invention. Thus, the present invention should not be limited by any of the above-described exemplary embodiments.

1. A process for desalination of seawater or brackish water comprising the steps of:
a. Passing a continuous flow of seawater or brackish water through a mixed bed ion exchange column containing, strong acid and strong base resin, in which the ion exchange groups are initially saturated with NH₄⁺ and HCO₃⁻ ions, to produce desalinated water containing essentially desorbed NH₄⁺ and HCO₃⁻ ions until the resin is exhausted;
b. Heating the desalinated water containing desorbed NH₄⁺ and HCO₃⁻ ions produced in the previous step to a temperature between 60-80° C. or to a lower temperature with reduced pressure to completely remove the ammonium bicarbonate solute as CO₂ and NH₃ gases, to produce desalinated product water;
c. Combining the released gases CO₂ and NH₃ with some portion of the produced desalinated product water to make an ammonium bicarbonate solution;
d. Concentrating the said ammonium bicarbonate solution by subjecting it to higher pressure and temperature to produce a super saturated ammonium bicarbonate regenerant solution;
e. Regenerating the exhausted resin in the ion exchanger column by passing the supersaturated ammonium bicarbonate regenerant solution by exchanging ammonium and bicarbonate ions in the regenerant solution with sodium and chloride (and Mg²⁺ and SO₄²⁻) ions in the exhausted resin while being heated to decompose the supersaturated ammonium bicarbonate regenerant to raise the partial pressures of both ammonia and carbon dioxide which drives the regeneration process;
f. Draining out the concentrated sodium chloride solution from the ion exchange column; and
g. Repeating the steps of a to f.

2. A process as defined in claim 1, where the volume of desalinated product water produced is higher than the volume of the ammonium bicarbonate regenerating solution used resulting in a net surplus of desalinated product water.

3. A process as defined in claim 2, wherein the concentration of ammonium bicarbonate solution is carried out under pressure between 1 to 10 atm and temperature between 40° to 80° C. to produce a regenerant solution having up to 8 molar concentration of ammonium bicarbonate.

4. A process as defined in claim 3, where the heated regenerant solution is fed under pressure into the ion exchange column containing the exhausted resin and the ion exchange column is continuously rolled or shaken to allow mixing for a period until the pressure in the vessel falls to a lower equilibrium value, indicating that the NH₄⁺ and HCO₃⁻ ions have replaced the resin absorbed seawater ions.

5. A process as defined in claim 4, wherein the temperature and pressure in the ion exchange column is reduced to ambient conditions prior to draining the concentrated sodium chloride solution.

6. A process as defined in claim 5, where the regeneration process is driven by a positive pressure increase, acting in only one direction.

7. A process as defined in claim 6, wherein guided ultrasonic waves are used to apply positive pressure increases transiently to pressurize all regions within the seawater-exhausted, mixed bed ion exchange resin immersed in a concentrated or supersaturated solution of ammonium bicarbonate within the ion exchange column, so as to drive a resin regeneration process via ion exchange.

8. A process as defined in claim 7, wherein the frequency of the guided ultrasonic waves is in the range of 20 kHz to 20 MHz.

9. A process according to claim 1, where magnesium in the form of magnesium carbonate or magnesium bicarbonate precipitate is recovered as a byproduct derived from the significant levels of Mg²⁺ present in seawater absorbed by the resin.

10. A process for the treatment of wastewater containing a dissolved electrolyte comprising the steps of:
a. Passing a continuous flow of the electrolyte wastewater through a mixed bed ion exchange column containing, strong acid and strong base resin, in which the ion exchange groups are initially saturated with NH₄⁺ and HCO₃⁻ ions, to produce an ammonium bicarbonate solution containing essentially desorbed NH₄⁺ and HCO₃⁻ ions until the resin is exhausted;
b. Heating the ammonium bicarbonate solution produced in the previous step to a temperature between 60-80° C. or to a lower temperature under reduced pressure to completely remove the ammonium bicarbonate solute as CO₂ and NH₃ gases, to produce treated product water;
c. Combining the released gases CO₂ and NH₃ with some portion of the treated product water to make an ammonium bicarbonate solution;
d. Concentrating the said ammonium bicarbonate solution by subjecting it to higher pressure and temperature to produce a super saturated ammonium bicarbonate regenerant solution;
e. Regenerating the exhausted resin in the ion exchanger column by passing the supersaturated ammonium bicarbonate regenerant solution by exchanging ammonium and bicarbonate ions in the regenerant solution with ions of the electrolyte in the exhausted resin while being heated to decompose the supersaturated ammonium bicarbonate regenerant to raise the partial pressures of both ammonia and carbon dioxide which drives the regeneration process;
f. Draining out the concentrated waste solution from the ion exchange column; and
g. Repeating the steps of a to f.

11. A process as defined in claim 10, where the volume of treated product water produced is higher than the volume of the ammonium bicarbonate regenerating solution used resulting in a net surplus of treated product water.

12. A process as defined in claim 11, wherein the concentration of ammonium bicarbonate solution is carried out under pressure between 1 to 10 atm and temperature between 40° to 80° C. to produce a regenerant solution having up to 8 molar concentration of ammonium bicarbonate.

13. A process as defined in claim 12, where the heated regenerant solution is fed under pressure into the ion exchange column containing the exhausted resin and the ion exchange column is continuously rolled or shaken to allow mixing for a period until the pressure in the vessel falls to a lower equilibrium value, indicating that the NH₄⁺ and HCO₃⁻ ions have replaced the resin absorbed electrolyte ions.

14. A process as defined in claim 13, wherein the temperature and pressure in the ion exchange column is reduced to ambient conditions prior to draining the concentrated waste electrolyte solution.

15. A process as defined in claim 14, where the regeneration process is driven by a positive pressure increase, forcing the ion exchange reaction in only one direction.

16. A process as defined in claim 15, wherein guided ultrasonic waves are used to apply positive pressure increase to transiently pressurize all regions within the exhausted, mixed bed ion exchange resin immersed in a concentrated or supersaturated solution of ammonium bicarbonate within the ion exchange column, so as to drive a resin regeneration process via ion exchange.

17. A process as defined in claim 16, wherein the frequency of the guided ultrasonic waves is in the range of 20 kHz to 20 MHz.

18. A process as defined in claim 10, for the removal of radioactive strontium (Sr²⁺) or rare earth metals from wastewater.

19. An apparatus for the treatment of an ionic solution by ion exchange comprising:
a mixed bed ion exchange column containing, strong acid and strong base resin, in which the ion exchange groups are initially saturated with NH₄⁺ and HCO₃⁻ ions, to produce treated water containing essentially desorbed NH₄⁺ and HCO₃⁻ ions until the resin is exhausted;
A means for heating the treated water containing desorbed NH₄⁺ and HCO₃⁻ ions to between 60-80° C. or to a lower temperature under reduced pressure to completely remove the ammonium bicarbonate solute as CO₂ and NH₃ gases, to produce product water; or at lower temperatures under reduced pressures;
A means for combining the released gases CO₂ and NH₃ with some portion of the produced product water to make an ammonium bicarbonate solution;
A means for concentrating the said ammonium bicarbonate solution by subjecting it to higher pressure and temperature to produce a super saturated ammonium bicarbonate regenerant solution;
A means for regenerating the exhausted resin in the ion exchanger column by passing the supersaturated ammonium bicarbonate regenerant solution for exchanging ammonium and bicarbonate ions in the regenerant solution with ions in the exhausted resin while being heated to decompose the supersaturated ammonium bicarbonate regenerant to raise the partial pressures of both ammonia and carbon dioxide which drives the regeneration process.
A means for draining out the concentrated waste solution from the ion exchange column, using either applied pressure or residual pressure from the regenerant process.

20. An apparatus as defined in claim 9, which further comprises a means for applying pressure acting transiently to pressurize all regions within the mixed bed ion exchange resin immersed in a concentrated or supersaturated solution of ammonium bicarbonate within the ion exchange column, so as to drive a resin regeneration process via ion exchange.

21. An apparatus as defined in claim 10, where the means of applying a transient pressure is via guided ultrasonic waves having a frequency range of 20 kHz to 20 MHz; or by using a spinning drum to generate a centrifugal pressure on the resin.
